(19) United States
(12) Patent Application Publication
(10) Pub. No.: US 2019/0360972 A1
(43) Pub. Date: Nov. 28, 2019

(54) SENSOR FOR A GAS TURBINE

(71) Applicant: Rolls-Royce Deutschland Ltd & Co KG, Blankenfelde-Mahlow (DE)

(72) Inventors: Linbo TANG, Ruesselsheim (DE); Felix ROSENBURG, Darmstadt (DE); Roland WERTHSCHUETZKY, Darmstadt (DE); Ralf RIEDEL, Darmstadt (DE)

(21) Appl. No.: 16/405,005

(22) Filed: May 7, 2019

(30) Foreign Application Priority Data
May 22, 2018 (DE) 10 2018 208 003.8

(51) Int. Cl. G01N 29/14; G01N 29/26; G01H 1/00; F01D 21/00; G01H 11/08

(52) U.S. Cl. CPC G01N 29/14; G01N 29/26; G01H 1/006; G01N 29/4436; G01H 11/08; G01N 2291/2693; F01D 21/003

(57) ABSTRACT

A sensor for a gas turbine includes a sensor element, including or consisting of a polymer-derived ceramic, and a pre-stressing device that is designed to pre-stress the sensor element against a surface. A method for producing a sensor for a gas turbine includes the following steps: providing a sensor element including or consisting of a polymer-derived ceramic, and providing a pre-stressing device that is designed to pre-stress the sensor element against a surface.

This application claims priority to German Patent Application DE102018208003.8 filed May 22, 2018, the entirety of which is incorporated by reference herein.

### DESCRIPTION

The present disclosure relates to a sensor for a gas turbine according to claim 1, to an arrangement, a gas turbine engine, and to a method for producing a sensor according to claim 12.

Piezoelectric, piezoresistive or capacitive sensors regularly have characteristics, e.g. a measurable frequency range, a compressive strength, and/or a temperature application range that do not allow for their use in certain application areas. For example, some areas of gas turbines, in particular of gas turbine engines, have high temperatures in the range of 300 or 400 degree Celsius, which many sensors, in particular some structure-borne sound sensors, cannot withstand or can do so only through elaborate measures.

It is the objective of the present invention to provide a sensor, in particular a structure-borne sound sensor that has a temperature stability that is as high as possible while also having a simple structure.

According to one aspect, a sensor for a gas turbine, in particular for a gas turbine engine, is provided. The sensor comprises a sensor element, comprising or consisting of a polymer-derived ceramic, and a pre-stressing device that is designed to pre-stress the sensor element against a surface (in particular in a spring-elastic manner).

In this manner, a sensor is provided which can have a high sensitivity while also having a simple structure, and which can be used at high temperatures of up to 400 degree Celsius and higher. In addition, the sensor can be embodied in a very pressure-stable manner. With the mentioned material of the sensor element, the defined pre-stress of the sensor element facilitates particularly precise measurements. The polymer-derived ceramic (polymer-derived ceramic, PDC) has piezoresistive characteristics.

The sensor can be formed and used as a strain sensor and/or as a structure-borne sound sensor.

The polymer-derived ceramic may e.g. be SiOC/C, also a silicon oxycarbide composite with a segregated carbon phase. This material in particular has piezoresistive characteristics that are particularly suitable for the use as a structure-borne sound sensor.

The sensor element comprises e.g. 6 to 20 vol % carbon, in particular 11 to 17 vol % carbon. Within these boundaries, particularly good sensor sensitivities and at the same time mechanical stability of the material are possible.

For an electrical contacting that is as good as possible, electrodes can be provided at the sensor element. The electrodes are in particular spaced apart from each other along an axis.

The axis along which the electrodes are spaced apart from each other at the sensor element can be oriented perpendicular to the force of the pre-stress if the sensor element is pre-stressed against the surface by means of the pre-stressing device.

Optionally, the pre-stressing device comprises a spring element with U-shaped spring sections and/or with an abutment section for abutment at the sensor element. The abutment section can be arranged between the spring sections. In this manner, a reliable mounting of the sensor element can be provided, which exerts a predefined force onto the sensor element.

The spring element can further have mounting sections for mounting the spring element at a structural component. Optionally, the spring sections are arranged between the mounting sections. The spring sections can be formed in such a manner that they press the abutment section against the surface with a force of 200 to 400 N, in particular of 300 N, if the mounting sections are mounted (in a correspondingly tight manner) at the surface (O). Thus, the pressing force can be predetermined and is independent from a screwing force with which the spring element is screwed to the structural component (as soon as a minimum screwing force is reached). The spring element may e.g. be formed in such a manner that the sensor element is arrangeable between the mounting sections and the abutment section. The spring element can define a reception area for the sensor element.

According to one aspect, an arrangement is provided that comprises a structural component for a gas turbine (or a structural component of a gas turbine) and at least one sensor according to any design described herein. The structural component has a surface, and the sensor element of the sensor is pre-stressed against the surface by means of the pre-stressing device of the sensor.

One aspect relates to a gas turbine engine for an aircraft, comprising a core engine that comprises a turbine, a compressor and a core shaft that connects the turbine with the compressor; a fan that is positioned upstream of the core engine, wherein the fan comprises multiple fan blades; and a gearbox that can be driven by the core shaft, wherein the fan can be driven by means of the gearbox with a lower rotational speed than the core shaft, and at least one structural component, in particular a disc according to any design described herein. The gas turbine engine further comprises at least one sensor according to any design that is described herein, or the previously described arrangement with such a sensor. The structural component at which the sensor is mounted can in particular be a part of a housing of the gas turbine engine, or a part of the gearbox.

In the gas turbine engine, the turbine can be a first turbine, the compressor can be a first compressor and the core shaft can be a first core shaft. Optionally, the core engine can further comprise a second turbine, a second compressor and a second core shaft that connects the second turbine to the second compressor; and the second turbine, the second compressor and the second core shaft can be arranged in such a manner that they can rotate with a higher rotational speed than the first core shaft.

According to one aspect, a method for producing a sensor for a gas turbine, in particular a sensor according to any design that is described herein, is provided. The method comprises the following steps: providing a sensor element comprising or consisting of a polymer-derived ceramic, and providing a pre-stressing device that is embodied for the purpose of pre-stressing the sensor element against a surface.

In this manner, a sensor can be provided that has a simple structure as well as a high sensitivity, and that can be used at high temperatures up to 400 degree Celsius and higher.

Providing the sensor element can comprise producing the sensor element at a synthesis temperature of more than 1500° C., in particular at 1600° C.+/−100° C. or 1600° C.+/−50° C. At that, a particularly stabile sensor element with a density of at least 2.2-2.4 g/cm³ and a porosity of under 1% can be obtained.

The method can further comprise the following steps: processing the contact surfaces of the sensor element by sputtering and attaching (spaced apart) electrodes at the processed contact surfaces. It has been shown that, with the material of the sensor element, in particular in this manner a particularly good, deformation-resistant contacting can be obtained, which facilitates a subsequent contacting of the contact wires (in particular gold wires) by means of gold paste. The sputtered layer may e.g. have a thickness of at least 70 nm.

The method can further comprise the following step: pre-stressing the sensor element against the surface of the structural component by means of the pre-stressing device, wherein the force of the pre-stress can in particular be oriented perpendicular to the arrangement of the electrodes.

As noted elsewhere herein, the present disclosure may relate to a gas turbine engine, such as for example an aircraft engine. Such a gas turbine engine may comprise a core engine comprising a turbine, a combustion device, a compressor, and a core shaft connecting the turbine to the compressor. Such a gas turbine engine may comprise a fan (having fan blades) located upstream of the core engine.

Arrangements of the present disclosure may be particularly, although not exclusively, beneficial for geared fans that are driven via a gearbox. Accordingly, the gas turbine engine may comprise a gearbox that is driven via the core shaft, with its drive driving the fan in such a manner that it has a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and the compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gearbox may be embodied to be driven by the core shaft that is configured to rotate (for example in use) at the lowest rotational speed (for example the first core shaft in the example above). For example, the gearbox may be embodied to be driven only by the core shaft that is configured to rotate (for example in use) at the lowest rotational speed (for example only by the first core shaft, and not the second core shaft, in the example above). Alternatively, the gearbox may be embodied to be driven by one or multiple shafts, for example the first and/or second shaft in the above example.

In a gas turbine engine as described and/or claimed herein, a combustion device may be provided axially downstream of the fan and the compressor (or the compressors). For example, the combustion device may be located directly downstream of the second compressor (for example at the exit thereof), if a second compressor is provided. By way of further example, the flow at the exit to the combustor may be provided to the inlet of the second turbine, if a second turbine is provided. The combustion device may be provided upstream of the turbine(s).

The or each compressor (for example the first compressor and the second compressor according to the above description) may comprise any number of stages, for example multiple stages. Each stage may comprise a row of rotor blades and a row of stator vanes, which may be variable stator vanes (i.e. in that their angle of incidence may be variable). The row of rotor blades and the row of stator vanes may be axially offset with respect to each other.

The or each turbine (for example the first turbine and second turbine according to the above description) may comprise any number of stages, for example multiple stages. Each stage may comprise a row of rotor blades and a row of stator vanes. The row of rotor blades and the row of stator vanes may be axially offset with respect to each other.

Each fan blade may have a radial span width extending from a root (or hub) at a radially inner gas-washed location, or from a 0% span position to a tip with a 100% span width. Here, the ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in a closed range bounded by any two values in the previous sentence (i.e., the values may represent upper or lower bounds). These ratios may commonly be referred to as the hub-to-tip ratio. The radius at the hub and the radius at the tip may both be measured at the leading edge (or the axially forwardmost) edge of the blade. The hub-to-tip ratio refers, of course, to the gas-washed portion of the fan blade, i.e. the portion that is located radially outside any platform.

The radius of the fan may be measured between the engine centerline and the tip of a fan blade at its leading edge. The fan diameter (which may generally be twice the radius of the fan) may be greater than (or on the order of) any of: 250 cm (about 100 inches), 260 cm, 270 cm (about 105 inches), 280 cm (about 110 inches), 290 cm (about 115 inches), 300 cm (about 120 inches), 310 cm, 320 cm (about 125 inches), 330 cm (about 130 inches), 340 cm (about 135 inches), 350cm, 360cm (about 140 inches), 370 cm (about 145 inches), 380 (about 150 inches) cm or 390 cm (about 155 inches). The fan diameter may be in a closed range bounded by any two of the values in the previous sentence (i.e. the values may represent upper or lower bounds).

The rotational speed of the fan may vary during operation. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range from 1700 rpm to 2500 rpm, for example in the range of between 1800 rpm to 2300 rpm, for example in the range of between 1900 rpm to 2100 rpm. Purely by way of further non-limitative example, the rotational speed of the fan at cruise conditions for an engine having a fan diameter in the range of between 320 cm to 380 cm may be in the range of between 1200 rpm to 2000 rpm, for example in the range of between 1300 rpm to 1800 rpm, for example in the range of between 1400 rpm to 1600 rpm.

In use of the gas turbine engine, the fan (with the associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as the fan tip radius at the leading edge multiplied by the angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (with all units in this paragraph being Jkg⁻¹K⁻¹/(ms⁻¹)²). The fan tip loading may be in a closed range bounded by any two of the values in the previous sentence (i.e. the values may represent upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements, the bypass ratio may be greater than (or on the order of): 10, 10.5, 11, 11.5, 12, 12.5, 13, 13.5, 14, 14.5, 15, 15.5, 16, 16.5, or 17. The bypass ratio may be in a closed range bounded by any two of the values in the previous sentence (i.e. the values may represent upper or lower bounds). The bypass duct may be substantially annular. The bypass duct may be radially outside the core engine. The radially outer surface of the bypass duct may be defined by a nacelle and/or a fan housing.

The overall pressure ratio of a gas turbine engine as described and/or claimed herein may be defined as the ratio of the stagnation pressure upstream of the fan to the stagnation pressure at the exit of the highest-pressure compressor (before entry into the combustion device). By way of non-limitative example, the overall pressure ratio of a gas turbine engine as described and/or claimed herein at cruising speed may be greater than (or on the order of): 35, 40, 45, 50, 55, 60, 65, 70, 75. The overall pressure ratio may be in a closed range bounded by any two of the values in the previous sentence (i.e. the values may represent upper or lower bounds).

Specific thrust of an engine may be defined as the net thrust of the engine divided by the total mass flow through the engine. At cruise conditions, the specific thrust of an engine as described and/or claimed herein may be less than (or on the order of): 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in a closed range bounded by any two of the values in the previous sentence (i.e. the values may represent upper or lower bounds). Such engines may be particularly efficient as compared to conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in a closed range bounded by any two of the values in the previous sentence (i.e. the values may represent upper or lower bounds). The thrust referred to above may be the maximum net thrust at standard atmospheric conditions at sea level plus 15 deg C (ambient pressure 101.3 kPa, temperature 30 deg C), with the engine being static

In use, the temperature of the flow at the entry to the high-pressure turbine may be particularly high. This temperature, which may be referred to as TET, may be measured at the exit to the combustion device, for example immediately upstream of the first turbine vane, which itself may be referred to as a nozzle guide vane. At cruise, the TET may be at least (or on the order of): 1400 K, 1450 K, 1500 K, 1550 K, 1600 K or 1650 K. The TET at cruise may be in a closed range bounded by any two of the values in the previous sentence (i.e. the values may represent upper or lower bounds). The maximum TET in use of the engine may be, for example, at least (or on the order of): 1700 K, 1750 K, 1800 K, 1850 K, 1900 K, 1950 K or 2000 K. The maximum TET may be in a closed range bounded by any two of the values in the previous sentence (i.e. the values may represent upper or lower bounds). The maximum TET may occur, for example, at a high thrust condition, for example at a maximum take-off (MTO) condition.

A fan blade and/or aerofoil portion of a fan blade as described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions that are manufactured by using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be present in the form of a dovetail that may be inserted into a corresponding slot in the hub/disc and/or may engage with the same in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow for the exit area of the bypass duct to be varied during operation. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may refer to the cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of descend.

Purely by way of example, the forward speed at the cruise condition may be any point in the range from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85, or in the range from 0.8 to 0.85. Any single speed within these ranges may be the cruise condition. For some aircrafts, the cruise conditions may be outside these ranges, for example below Mach 0.7 or above Mach 0.9.

Purely by way of example, the cruise conditions may correspond to standard atmospheric conditions at an altitude that is in the range from 10000 m to 15000 m, for example in the range from 10000 m to 12000 m, for example in the range from 10400 m to 11600 m (around 38000 ft), for example in the range from 10500 m to 11500 m, for example in the range from 10600 m to 11400 m, for example in the range from 10700 m (around 35000 ft) to 11300 m, for example in the range from 10800 m to 11200 m, for example in the range from 10900 m to 11100 m, for example on the order of 11000 m. The cruise conditions may correspond to standard atmospheric conditions at any given altitude in these ranges.

Purely by way of example, the cruise conditions may correspond to the following: a forward Mach number of 0.8; a pressure of 23000 Pa; and a temperature of −55° C.

As used anywhere herein, “cruise” or “cruise conditions” may refer to the aerodynamic design point. Such an aerodynamic design point (or ADP) may correspond to the conditions (comprising, for example, one or more of the Mach Number, environmental conditions and thrust requirement) in which the fan is designed to operate. This may mean, for example, the conditions at which the fan (or the gas turbine engine) is designed to have optimum efficiency.

During operation, a gas turbine engine as described and/or claimed herein may operate at the cruise conditions defined elsewhere herein. Such cruise conditions may be determined by the cruise conditions (for example the mid-cruise conditions) of an aircraft to which at least one (for example two or four) of the gas turbine(s) engine may be mounted in order to provide propulsive thrust.

The skilled person will appreciate that, except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

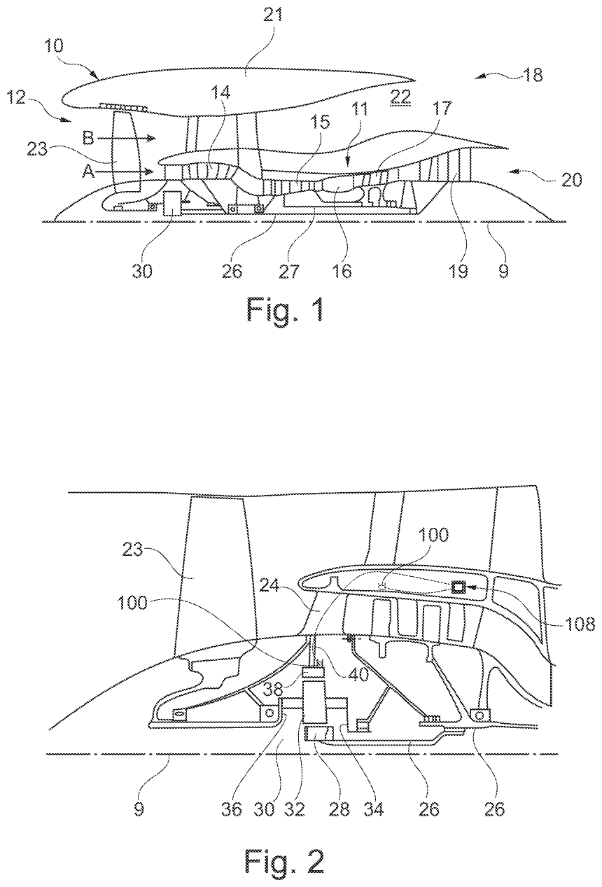

FIG. 1 shows a lateral sectional view of a gas turbine engine;

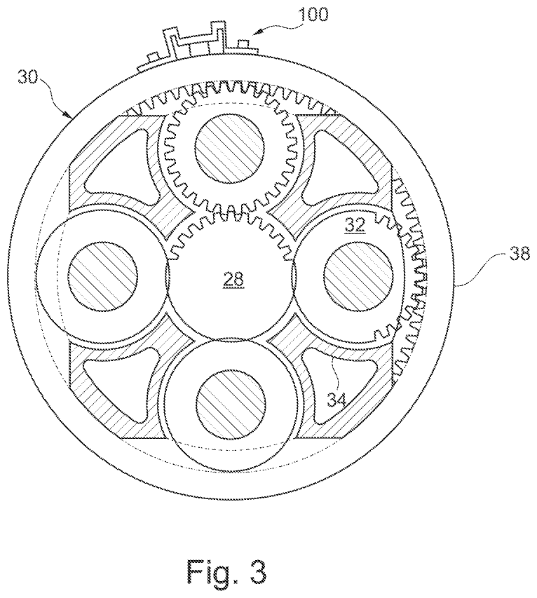

FIG. 2 shows an enlarged lateral sectional view of an upstream section of a gas turbine engine;

FIG. 3 shows a partial cut-away view of a gearbox for a gas turbine engine;

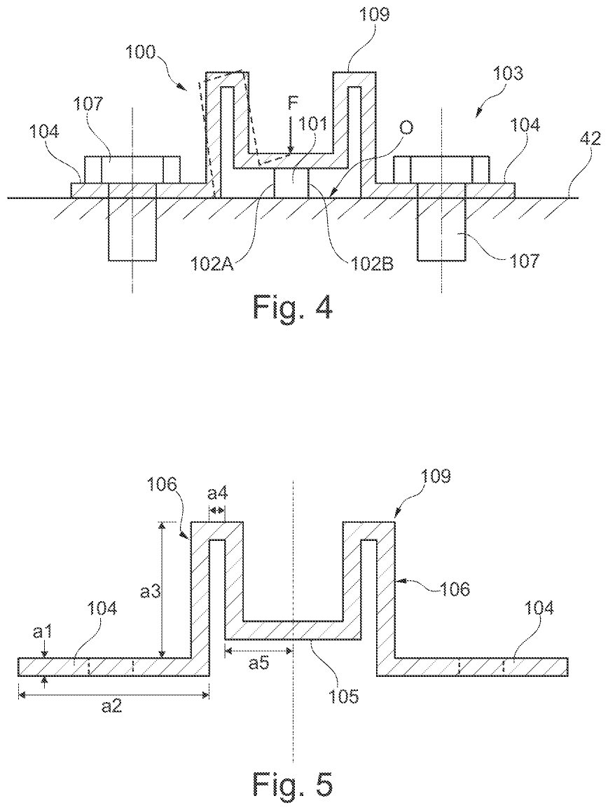

FIG. 4 shows a structure-borne sound sensor of the gas turbine engine with a sensor element and a pre-stressing device;

FIG. 5 shows a spring element of the pre-stressing device of the structure-borne sound sensor;

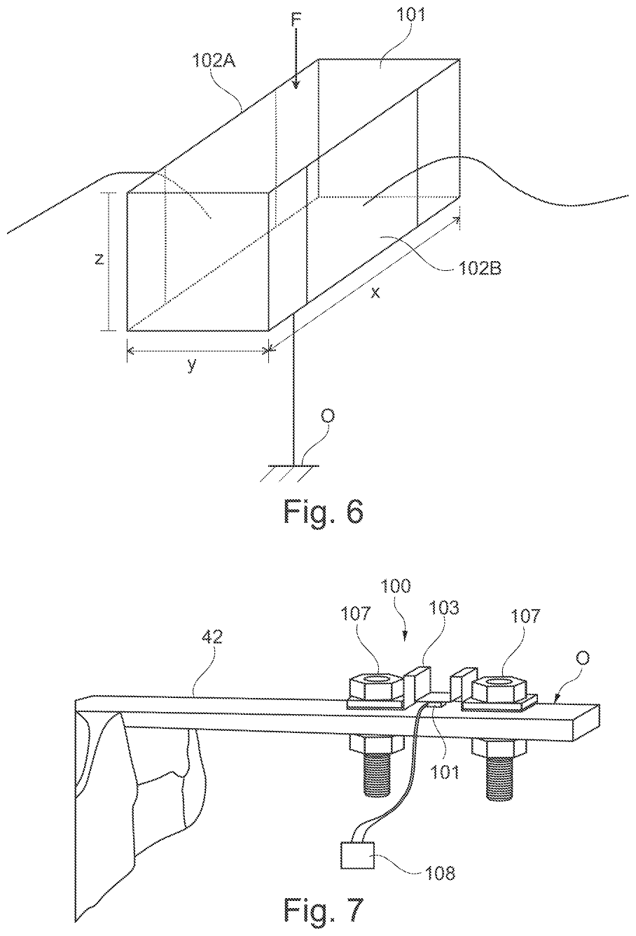

FIG. 6 shows the sensor element of the structure-borne sound sensor;

FIG. 7 shows the structure-borne sound sensor in a state in which it is mounted at a structural component of the gas turbine engine; and

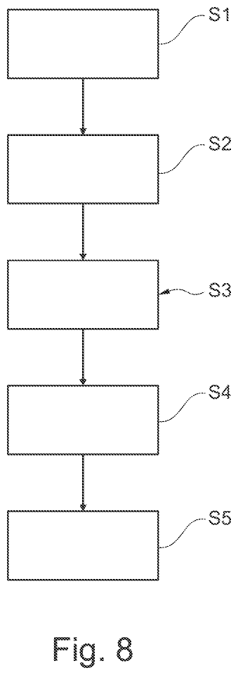

FIG. 8 shows a method for producing the structure-borne sound sensor.

FIG. 1 shows a gas turbine engine 10 with a main rotational axis 9. The gas turbine engine 10 comprises an air intake 12 and a fan 23 that generates two airflows: a core airflow A and a bypass airflow B. The gas turbine engine 10 comprises a core 11 that receives the core air flow A. The core engine 11 comprises, with respect to the axial flow order, a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass channel 22 and a bypass thrust nozzle 18. The bypass air flow B flows through the bypass channel 22. Via a shaft 26 and an epicyclic planetary gearbox 30, the fan 23 is attached to a low-pressure turbine 19, and is driven by the same.

During operation, the core airflow A is accelerated and compressed by the low-pressure compressor 14, and guided into the high-pressure compressor 15 where further compression takes place. The air that is discharged from the high-pressure compressor 15 in a compressed state is directed into the combustion device 16 where it is mixed with fuel and the mixture is combusted. The resulting hot combustion products are then propagated through the high-pressure turbine 17 and the low-pressure turbine 19 and thus drive it by before being discharged through the core exhaust nozzle 20 for providing a certain thrust. The high-pressure turbine 17 drives the high-pressure compressor 15 via a suitable interconnecting shaft 27. The fan 23 usually provides the greatest portion of the propulsive thrust. The epicyclic planetary gearbox 30 is a reduction gear.

An exemplary arrangement for a geared fan gas turbine engine 10 is shown in FIG. 2. The low pressure turbine 19 (see FIG. 1) drives the shaft 26, which is coupled to a sun gear 28 of the epicyclic planetary gearbox 30. Located radially outwardly of the sun gear 28 and intermeshing therewith is a plurality of planetary gears 32 that are coupled with each other by a planet carrier 34. The planet carrier 34 forces the planetary gears 32 to precess around the sun gear 28 in synchronicity whilst enabling each planetary gear 32 to rotate about its own axis. Via linkages 36, the planet carrier 34 is coupled to the fan 23 in order to cause its rotation about the rotational axis 9. An annulus or ring gear 38 that is coupled via the linkage 40 to a stationary support structure 24, is located radially outside of the planetary gears 32 and intermeshes therewith.

Note that the terms “low pressure turbine” and “low pressure compressor” as used herein may be taken to refer to the turbine stages with the lowest pressure and the compressor stages with the lowest pressure (i.e., not including the fan 23) and/or refer to the turbine and compressor stages that are connected to each other by the interconnecting shaft 26 with the lowest rotational speed in the engine (i.e., not including the gearbox output shaft that drives the fan 23). In some documents, the “low pressure turbine” and the “low pressure compressor” referred to herein may alternatively also be known as an “intermediate pressure turbine” and an “intermediate pressure compressor”. Where such alternative nomenclature is used, the fan 23 may be referred to as a first or lowest pressure stage.

The epicyclic planetary gearbox 30 is shown in more detail in FIG. 3 by way of example. The sun gear 28, the planetary gears 32 and the ring gear 38 respectively comprise teeth at their circumference to facilitate meshing with other gears. However, with a view to clarity, only exemplary sections of the teeth are shown in FIG. 3. Although four planetary gears 32 are shown, it will be clear to a person skilled in the art that more or less planetary gears 32 can be provided within the scope of the claimed invention. Practical applications of the epicyclic planetary gearbox 30 generally comprise at least three planetary gears 32.

The epicyclic planetary gearbox 30 shown in FIGS. 2 and 3 by way of example is a planetary gearbox, in which the planetary carrier 34 is coupled via linkages 36 to an output shaft, wherein the ring gear 38 is fixedly attached. However, it is also possible to use any other suitable type of a planetary gearbox 30. By way of further example, the planetary gearbox 30 may comprise a star arrangement, in which the planet carrier 34 is supported in a fixed manner, and the ring (or annulus) gear 38 is rotatable. In such an arrangement, the fan 23 is driven by the ring gear 38. By way of further alternative example, the gearbox 30 may be a differential gearbox in which the ring gear 38 as well as the planet carrier 34 are rotatable.

It will be obvious that the arrangement shown in FIGS. 2 and 3 serves merely as an example, and the scope of the present disclosure also comprises various alternatives. Purely by way of example, any suitable arrangement may be used for arranging the gearbox 30 in the gas turbine engine 10 and/or for connecting the gearbox 30 to the gas turbine engine 10. By way of further example, the connections (such as the linkages 36, 40 in the example of FIG. 2) between the gearbox 30 and other parts of the gas turbine engine 10 (such as the input shaft 26, the output shaft and the stationary support structure 24) may have a certain degree of stiffness or flexibility. By way of further example, any suitable arrangement of the bearings between rotating and stationary parts of the gas turbine engine 10 (for example between the input and output shafts of the gearbox 30 and the fixed structures, such as for example the gearbox casing) may be used, and the disclosure is not limited to the exemplary arrangement of FIG. 2. For example, where the gearbox 30 has a star arrangement (as described above), the person skilled in the art would readily understand that the arrangement of output and support connections and bearing locations would typically be different from that shown in FIG. 2.

Accordingly, the present disclosure extends to a gas turbine engine 10 having any arrangement of gearbox styles (for example star arrangement or epicyclic planetary arrangements), support structures, input and output shaft arrangement, and bearing locations.

Optionally, the gearbox may drive additional and/or alternative components (e.g. the intermediate pressure compressor and/or a booster compressor).

Other turbine engines to which the present disclosure may be applied may have alternative configurations. For example, such engines may have a different number of compressors and/or turbines and/or a different number of interconnecting shafts. By way of further example, the gas turbine engine shown in FIG. 1 has a split flow nozzle 20, 22, meaning that the flow through the bypass channel 22 has its own nozzle that is separate from and arranged radially outside of the core engine exhaust nozzle 20. However, this is not to be taken in a limiting manner, and any aspect of the present disclosure may also apply to engines in which the flow through the bypass channel 22 and the flow through the core engine 11 is intermixed or combined in front (or upstream) of a single nozzle, which may be referred to as a mixed flow nozzle. One or both nozzles may have a fixed or variable cross section (independently of whether a mixed or a partial flow is present). Whilst the example described herein relates to a turbofan engine, the disclosure may apply, for example, to any type of turbine engine, such for example in an open rotor (in which the fan stage is not surrounded by an engine nacelle) or to a turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the view in the FIG. 1 view). The axial, radial and circumferential directions are mutually perpendicular.

As illustrated in FIGS. 2 and 3, the gas turbine engine 10 comprises at least one structure-borne sound sensor 100, concretely multiple structure-borne sound sensors 100, for detecting structure-borne sound. By means of the structure-borne sound sensors 100, the function of different structural components of the gas turbine engine 10 can be monitored. For example, changes in a frequency spectrum measured by one of the structure-borne sound sensors 100 can indicate wear or an imminent defect of a structural component.

One of the structure-borne sound sensors 100 is mounted at the stationary support structure 24. A further structure-borne sound sensor 100 is mounted at the ring gear 38 of the gearbox 30. Further structure-borne sound sensors 100 can be mounted at other structural components of the gas turbine engine 10, e.g. in the area of shaft bearings, at a housing shell or at a turbine 17, 19.

The structure-borne sound sensors 10 are connected to an evaluation unit 108. The evaluation unit 108 acquires measurement values of the structure-borne sound sensors 100. For example, the evaluation unit 108 determines a frequency spectrum of the acquired measurement values of each of the structure-borne sound sensors 100. The evaluation unit 108 can analyze the frequency spectrum (in particular continuously), e.g. compare it with a predefined comparison spectrum to detect wear or an imminent defect of a structural component.

In the following, the structure of the structure-borne sound sensors 100 is explained in more detail.

FIG. 4 shows a structure-borne sound sensor 100 in a cross-sectional view. The structure-borne sound sensor 100 comprises a sensor element 101 and a pre-stressing device 103.

The sensor element 101 is made of a polymer-derived ceramic. In the shown example, the sensor element 101 comprises a silicon oxycarbide (SiOC). In the present case, the sensor element 101 has a silicon oxycarbide phase and a carbon phase, concretely a segregated carbon phase. The sensor element 101 consists at least predominantly of a silicon oxycarbide nanocomposite, which is also referred to as SiOC/C. The sensor element 101 comprises e.g. 12 vol % carbon, wherein in general in particular 11 to 17 vol % carbon facilitate particularly good electrical characteristics for precise structure-borne sound measurements. The sensor element 101 has piezoelectric characteristics. The silicon oxycarbide nanocomposite material is particularly temperature stable and can e.g. be used at temperatures of 400° C.

The sensor element 101 further comprises two electrodes 102A, 102B at opposite sides of the sensor element 101.

Between the electrodes 102A, 102B, the sensor element 101 has an electrical resistance of e.g. 100 ohm or more, e.g. 100 up to 500 ohm, in the unloaded state. The polymer-derived ceramic has piezoelectric characteristics, i.e. a pressure or a traction at the sensor element 101 causes a change in the electrical resistance. Thus, strains and vibrations acting on the sensor element can be acquired through a measurement of the resistance between the electrodes 102A, 102B.

The pre-stressing device 103 comprises a spring element 109 and multiple, in the present case two, attachment elements for attaching the spring element 109 at a surface O of a structural component 42 for which the structure-borne sound is to be measured. In the present case, the attachment elements are screws 107 (e.g. with the size M17).

As is in particular illustrated based on FIGS. 4 and 5, the spring element 109 has a multiply bent shape. Here, a flat abutment section 105 is arranged between two respectively U-shaped spring sections 106. The U-shaped spring sections 106 respectively have two legs. As in the shown example, the legs can extend in parallel to each other at least in certain sections. Respectively one leg of the spring sections 106 adjoins the abutment section 105 and connects the respective spring section 106 to the abutment section 105. In the present example, this leg (at least in an unloaded state) extends perpendicular to the abutment section 105. The respectively other leg respectively adjoins a mounting section 104 and connects the respective spring section 106 to the mounting section 104. In the present example, this leg extends (at least in an unloaded state) in a rectangular manner to the mounting section 104. At least in the unloaded state, the legs of each spring section 106 extend in parallel to each other. The mounting sections 104 and the abutment section 105 extend (again at least in the unloaded state) in parallel to each other, and in planes that are offset with respect to each other. Thus, a reception area for the sensor element 101 is provided in between them.

The spring element 109 is made of spring steel. The spring element 109 is formed in one piece. In the present case, the spring element 109 is a multiply bent strip of a flat material. In an alternative design, the spring element is formed in a bowl-shaped manner, e.g. rotationally symmetrical about an axis perpendicular through the center of the abutment section 105. In that case, the cross-section e.g. corresponds to the cross-section according to FIG. 4.

According to FIG. 4, the sensor element 101 is arranged between the mounting sections 104 and the abutment section 105. By means of the screws 107, the spring element 109 is fixedly screwed to the structural component 42. The screws 107 are tightened so strongly that they press the abutment sections 104 against the surface O respectively with a screwing force of e.g. 200 N. The length of the legs of the spring sections 106 and the dimensions of the sensor element 101 are designed such that the abutment section 105 pre-stresses the sensor element 101 against the surface, e.g. with a pressing force F of 300 N. Here, the spring sections 106 are bent in a spring-elastic manner, as is illustrated in FIG. 4 by a dashed line.

Due to the shown design of the spring element 109, from a minimum screwing force on, the pressing force F is independent of the screwing force. The sensor element 101 is thus insensitive to excessively tightened screws, which can make mounting of the force sensor 100 easier. In addition, the spring element 109 provides a pre-defined pressing force F, whereby the measuring results of the structure-borne sound sensor 100 can be particularly reliable.

It has been shown that through pre-stressing the sensor element 101, furthermore, a particularly good, in particular reproducible quality of the measurement can be obtained. Further, it is not necessary to use an adhesive or a plummet or the like for attaching the sensor element 101 at the surface O. Such intermediate media can e.g. negatively impact the resolution of the measurement. In the structure-borne sound sensor 100 according to FIG. 4, the sensor element 101 abuts directly (without an intermediate medium being arranged in between) at the surface O, in particular in a planar manner.

Further, the sensor element 101 can be designed as a solid due to its ceramic characteristics. An additional deformation body, as customary in other sensors, is not necessary.

In an exemplary embodiment, the strength a1 of the spring element 109 is 0.5 mm, the length a2 of the mounting sections 104 is 31.5 mm, the length a3 of the legs of the spring sections 106 respectively adjoining the mounting section 104 is 13.5 mm, the distance a4 of the two legs of each of the spring sections 106 to each other is 2 mm, and half the length a5 of the abutment section 105 is 10 mm.

FIG. 6 shows the sensor element 101 (FIGS. 4 to 6 are schematic and not to scale). The sensor element 101 is formed in the shape of a cuboid. In an exemplary embodiment, the sensor element 101 has a length×of 10 mm, a width y of 3 mm, and a height z of 3 mm. The electrodes 102A, 102B are arranged at opposite surfaces of the sensor element 101 and thus spaced apart from each other (here by the width y of the sensor element 101).

The sensor element 101 and the spring element 109 are arranged in such a manner with respect to each other that the pressing force F extends perpendicular to the axis (here along the width y) along which the electrodes 102A, 102B are arranged spaced apart from each other. A current flux between the electrodes 102, 102B does not extend along a force path of the pressing force F. In this manner, it can be prevented that the strength of the pressing force F, in particular a change in the pressing force F, influences the measuring results.

The electrodes 102A, 102B can e.g. be contact pads, which may e.g. comprise or consist of gold.

FIG. 7 shows the sensor arrangement 101 mounted at the structural component 42. The structural component 42 is a structural component of the gas turbine engine 10. The electrodes 102A, 102B of the sensor element 101 are electrically connected to the evaluation unit 108 via signal lines. The evaluation unit 108 e.g. measures the electrical resistance of the sensor element 101 (from the one electrode 102A to the other electrode 102B). For this purpose, the evaluation unit 108 may e.g. be embodied for applying a voltage to the electrodes 102A, 102B.

Alternatively or additionally, the evaluation unit 108 can be embodied for the purpose of measuring a voltage between the electrodes 102A, 102B.

A comparative measurement with a small plate made of Langasite, which has also been mounted at the structural component 42, has yielded the result that the sensor element 101 generates reliable measuring results of vibration events. The sensor element 101 could detect frequencies of up to 100 kHz. The material of the sensor element 101 has a high compressive strength. For example, the sensor element 101 has a Youngs modulus of 100 GPa.

Referring to FIG. 8, a method for producing a sensor, in particular the previously described structure-borne sound sensor 100, is described in the following.

In a first step S1, a sensor element 101 is provided that comprises a polymer-derived ceramic or that consist of the same at least predominantly, in particular completely.

Providing the sensor element 101 in particular comprises producing the sensor element 101. Here, for example a preceramic polymer resin can be used, for example Polyramic® SPR-212, SPR-684 or SPR-688 by the company Starfire Systems Ltd. or Belsil® PMS-MK or Silres® 604 by Wacker Chemie AG. Particularly good results can be obtained with SPR-212 and Belsil® PMS-MK. The polymer is thermally cured for two hours in a furnace, e.g. at 250 degree Celsius. Subsequently, a two-hour pyrolysis at 1100 degree Celsius is performed with a heating and cooling rate of 100 degree Celsius per hour in an argon atmosphere. The resulting product is ground into a powder to a particle size of no more than 40 micrometers. The powder is hot-pressed for 15 minutes and with a heating rate of 320 degree Celsius per minute at 1600 degree Celsius (in an argon atmosphere), wherein a uniaxial pressure of at least 50 MPa is exerted. It has been shown that at this temperature of 1600 degree Celsius a lower porosity of less than 1% can be obtained, without any significant loss of the carbon phase.

The resulting monolith can e.g. be cut into a cuboid shape. For a surface that is as flat as possible, the obtained sensor element 101 can be polished e.g. by means of diamond polisher.

The sensor element 101 consists of SiOC/C, a composite with an amorphous glass-like matrix and a carbon phase that form a mutually perculatively penetrating network.

For a particularly high sensitivity, the carbon content in the sensor element 101 is at 6 to 20 vol %, in particular at 11 to 17 vol %. The ohmic resistance of the unloaded sensor element 101 may e.g. be 100 ohm. By varying the (segregated) carbon phase, the sensitivity of the sensor element 101 can be set as required.

In a further step S2, a pre-stressing device 103 is provided, which is formed in such a manner that it can pre-stress the sensor element 101 in a spring-elastic manner against an in particular flat surface O, e.g. with a pre-defined force (for example 300 N).

In a further step S3, which may also occur before the step S2 of providing the pre-stressing device 103, the surfaces of the sensor element 101 are processed by sputtering (that is, by bombardment with energy rich ions).

Subsequently, in a step S4, one electrode 102A, 102B is attached at the processed surfaces each, in particular a wire with gold paste is burned in, respectively.

In a further step S5, the sensor element 101 is pre-stressed in a spring-elastic manner against a surface O of a structural component by means of the pre-stressing device 103.

The thus produced structure-borne sound sensor 100 is suitable for being used to measure the structure-borne sound at the gas turbine engine 10, in particular also for being used at structural components which have a temperature of up to 400 degree Celsius during operation, or the environment of which has a temperature of up to 400 degree Celsius during operation.

Alternatively or additionally, the structure-borne sound sensor 101 can also be used as a strain sensor.

It is to be understood that the invention is not limited to the above described embodiments and various modifications and improvements can be realized without departing from the concepts described herein. Except where they are mutually exclusive, any of the features can be used separately or in combination with any other features, and the disclosure extends to all combinations and sub-combinations of one or multiple features described herein and includes the same.

### PARTS LIST

9 main rotational axis
10 gas turbine engine
11 core engine
12 air intake
14 low-pressure compressor
15 high-pressure compressor
16 compressor device
17 high-pressure turbine
18 bypass thrust nozzle
19 low-pressure turbine
20 core thrust nozzle
21 engine nacelle
22 bypass channel
23 fan
24 stationary support structure
26 shaft
27 connecting shaft
28 sun gear
30 gearbox
32 planetary gears
34 planetary carrier
36 linkage
38 ring gear
40 linkage
42 structural component
100 structure-borne sound sensor (sensor)
101 sensor element
102A, 102B electrode
103 pre-stressing device
104 mounting section
105 abutment section
106 spring section
107 screw
108 evaluation unit
109 spring element
A core air flow
a1-a5 dimensions
B bypass air flow
F pressing force
O surface
x, y, z dimensions

1. Sensor for a gas turbine, with
a sensor element, comprising or consisting of a polymer-derived ceramic, and
a pre-stressing device, that is designed to pre-stress the sensor element against a surface.

2. Sensor according to claim 1, wherein the sensor is formed as an structure-borne sound sensor.

3. Sensor according to claim 1, wherein the polymer-derived ceramic is SiOC/C.

4. Sensor according to any claim 1, wherein the sensor element comprises 6 to 20 vol % carbon, in particular 11 to 17 vol %.

5. Sensor according to claim 1, wherein electrodes arranged at a distance from each other along an axis are provided at the sensor element.

6. Sensor according to claim 5, wherein the axis along which the electrodes are arranged at the sensor element spaced apart from each other is aligned perpendicular to the force of the pre-stress when the sensor element is pre-stressed against the surface by means of the pre-stressing device.

7. Sensor according to claim 1, wherein the pre-stressing device has a spring element with a U-shaped spring sections and an abutment section for abutment at the sensor element, wherein the abutment section is arranged between the spring sections.

8. Sensor according to claim 7, wherein the spring element further has mounting sections, between which the spring sections are arranged, wherein the spring sections are embodied in such a manner that they press the abutment section with a force of 200 up to 400 N, in particular 300 N, against the surface when the mounting sections are mounted at the surface.

9. Arrangement with a structural component for a gas turbine and at least one sensor according to claim 1, wherein the structural component has a surface, and the sensor element is pre-stressed against the surface by means of the pre-stressing device.

10. Gas turbine engine for an aircraft, comprising:
a core engine, comprising a turbine, a compressor and a core engine shaft for connecting the turbine to a compressor,
a fan upstream of the core engine, wherein the fan has multiple fan blades, and
a gearbox that can be driven by the core shaft , wherein the fan can be driven by means of the gearbox with a lower rotational speed than the core shaft,
at least one sensor according to claim 1 or an arrangement.

11. Gas turbine engine according to claim 10, wherein:
the turbine is a first turbine, the compressor is a first compressor and the core shaft is a first core shaft;
the core engine further comprises a second turbine, a second compressor and a second core shaft that connects the second turbine to the second compressor; and
the second turbine, the second compressor and the second core shaft are arranged such that they rotate with a higher rotational speed than the first core shaft.

12. Method for producing a sensor for a gas turbine, in particular a sensor according to claim 1, with the following steps:
providing a sensor element comprising or consisting of a polymer-derived ceramic, and
providing a pre-stressing device that is designed to pre-stress the sensor element against a surface.

13. Method according to claim 12, wherein providing the sensor element comprises manufacturing the sensor element at a synthesis temperature of more than 1500° C., in particular at 1600° C.+/−100° C.

14. Method according to claim 12, further comprising the following steps:
processing of contact surfaces of the sensor element by means of sputtering, and
attaching electrodes at the processed contact surfaces.

15. Method according to claim 12, further comprising the following step: pre-stressing the sensor element against the surface by means of the pre-stressing device.
